(19) United States
(12) Patent Application Publication
(10) Pub. No.: US 2004/0258957 A1
(43) Pub. Date: Dec. 23, 2004

(54) Organic electroluminescent device and manufacturing method thereof

(76) Inventors: Pei-Chuan Yeh, Hsinchu City (TW); Tung-Sheng Cheng, Hsinchu (TW)

Correspondence Address: BIRCH STEWART KOLASCH & BIRCH, PO BOX 747, FALLS CHURCH, VA, 22040-0747, US

(21) Appl. No.: 10/868,063

(22) Filed: Jun. 16, 2004

(30) Foreign Application Priority Data
Jun. 18, 2003 (TW) 092116603
Jun. 18, 2003 (TW) 092116604

(51) Int. Cl. H05B 33/12; H05B 33/10

(52) U.S. Cl. 428/690; 428/917; 428/213; 313/504; 313/505; 313/506; 257/88; 427/66

(57) ABSTRACT

An organic electroluminescent device comprises a transparent substrate, a first electrode, an organic light-emitting layer, an electron-injecting layer and a second electrode. In this case, the first electrode, the organic light-emitting layer, the electron-injecting layer and the second electrode are disposed on the transparent substrate in sequence. Furthermore, the organic light-emitting layer includes a plurality of organic electroluminescent units. The electron-injecting layer includes a plurality of electron-injecting units, which are respectively disposed on the organic electroluminescent units, and at least two electron-injecting units are made of different materials.

### BACKGROUND OF THE INVENTION

1. Field of Invention

The invention relates to a light-emitting device and the manufacturing method thereof and, in particular, to an organic electroluminescent device and the manufacturing method thereof.

2. Related Art

An organic electroluminescent device is an active light-emitting device, which can be used as a flat panel display or a light source. The organic electroluminescent device has the advantages of self-luminescence, wide viewing angle, low power consumption, flexible display, easier manufacture process, low cost, wide operation temperature range, and fast response rate.

As shown in FIG. 1, a conventional organic electroluminescent device 1 includes a transparent substrate 11, a first electrode 12, a hole-injecting layer 13, an organic light-emitting layer 14, an electron-injecting layer 15, and a second electrode 16. The first electrode 12, the hole-injecting layer 13, the organic light-emitting layer 14, the electron-injecting layer 15 and the second electrode 16 are sequentially disposed on the transparent substrate 11. The organic light-emitting layer 14 includes a plurality of organic electroluminescent units 141, 142, and 143, and those organic electroluminescent units may be formed of different organic materials in view of different requirements. The electron-injecting layer 15 includes a plurality of electron-injecting units 151, 152, and 153. These electron-injecting units have the same thickness, and are made of the same material.

In the conventional organic electroluminescent device 1 as shown in FIG. 1, the organic light-emitting layer 14 includes a first organic electroluminescent unit 141, a second organic electroluminescent unit 142, and a third organic electroluminescent unit 143. The first organic electroluminescent unit 141 is made of CN-PPV, and emits red light (indicated by arrow R). The second organic electroluminescent unit 142 is made of MEH-PPV, and emits green light (indicated by arrow G). The third organic electroluminescent unit 143 is made of DPBP-PPV, and emits blue light (indicated by arrow B). The organic electroluminescent device I can thus generate different visual effects by adjusting the ratio between the red, green, and blue lights.

In the conventional organic electroluminescent device 1 shown in FIG. 1, the electron-injecting layer 15 includes a first electron-injecting unit 151, a second electron-injecting unit 152, and a third electron-injecting unit 153. The first electron-injecting unit 151, the second electron-injecting unit 152 and the third electron-injecting unit 153 are made of a unitary material such as calcium (Ca) and have the same thickness. The electron-injecting layer 15 is to enhance the electron-injecting efficiency between the second electrode 16 and the organic light-emitting layer 14. The thickness and the material of the electron-injecting layer 15 affect the purity of the color, the brightness, and the light-emitting efficiency of the organic electroluminescent device 1.

As mentioned above, the thickness and the material of the electron-injecting layer affect the purity of the color, the brightness, and the light-emitting efficiency of the organic electroluminescent device. To enhance the electron-injecting efficiency between the organic light-emitting layer and the second electrode, the material and the thickness of the electron-injecting unit are selected in view of the material of the organic electroluminescent units. However, since the electron-injecting layer of the conventional organic electroluminescent device is made of the same material with the same thickness, one cannot enhance the electron-injecting efficiencies of different organic electroluminescent units individually. This affects the purity of the color, the brightness, and the light-emitting efficiency of the organic electroluminescent device.

Therefore, how to increase the electron-injecting efficiency between the organic light-emitting layer and the second electrode for elevating the color-purity, brightness and radiating efficiency of the organic electroluminescent device is an important topic.

### SUMMARY OF THE INVENTION

In view of the above, the invention is to provide an organic electroluminescent device having a high electron-injecting efficiency between the organic light-emitting layer and the second electrode and the manufacture thereof.

Therefore, to achieve the above, an organic electroluminescent device according to the invention comprises a transparent substrate, a first electrode, an organic light-emitting layer, an electron-injecting layer and a second electrode, wherein the first electrode is disposed on the transparent substrate, the organic light-emitting layer is disposed on the first electrode including a plurality of organic electroluminescent units, the electron-injecting layer is disposed on the organic light-emitting layer including a plurality of electron-injecting units, and at least two electron-injecting units are made of different materials, the second electrode is disposed on the electron-injecting layer.

To achieve the above, the manufacture method of the organic electroluminescent device according to the invention is forming a first electrode layer on a transparent substrate, forming an organic light-emitting layer composed of a plurality of organic electroluminescent units on the first electrode, forming at least one first electron-injecting unit wherein the electron-injecting is composed a first material, forming at least one second electron-injecting unit on the organic light-emitting layer wherein the second electron-injecting unit is composed a second material, forming a second electrode layer on a electron-injecting layer. The first material and second material are different. The first electron-injecting unit and the second electron-injecting unit constitute the electron-injecting layer. The thickness of the first electron-injecting unit and the second electron-injecting unit could be different depending on the demand.

As mentioned above, the organic electroluminescent device according to the invention has a plurality of electron-injecting units, wherein at least two electron-injecting units are respectively composed by different materials, in other words, the invention could respectively provide electron-injecting unit in different materials for different organic electroluminescent units in different materials. The electron-injecting unit could be respectively formed in different thicknesses depending on the demand to elevate the electron-injecting efficiency between the organic light-emitting layer and the second electrode, moreover, to elevate the color purity, brightness and the light-emitting efficiency.

### BRIEF DESCRIPTION OF THE DRAWINGS

The invention will become more fully understood from the detailed description given hereinbelow illustration only, and thus is not limitative of the present invention, and wherein:

FIG. 1 is a sectional schematic view showing an organic electroluminescent device in the prior art;

FIG. 2 is a sectional schematic view showing an organic electroluminescent device according to the first embodiment of the invention;

FIG. 3 is a sectional schematic view showing the organic light-emitting layer of the organic electroluminescent device according to the first embodiment of the invention;

FIG. 4 is another sectional schematic view showing the organic electroluminescent device according to the first embodiment of the invention;

FIG. 5A to 5E are schematic views illustrating the steps of the manufacturing method for the organic electroluminescent device according to the second embodiment of the invention;

FIG. 6 is a schematic view showing the top view of the organic light-emitting layer according to the second embodiment of the invention;

FIG. 7 is a schematic view showing the organic light-emitting layer of the organic light-emitting layer according to the second embodiment of the invention;

FIG. 8 is a schematic diagram showing a mask used in the manufacturing method according to the second embodiment of the invention;

FIG. 9 is a schematic view showing the organic electroluminescent device manufactured by the method of the second embodiment of the invention;

FIG. 10A is a schematic diagram showing a first mask used in the manufacturing method according to the second embodiment of the invention;

FIG. 10B is a schematic diagram showing a second mask used in the manufacturing method according to the second embodiment of the invention;

FIG. 10C is a schematic diagram showing a third mask used in the manufacturing method according to the second embodiment of the invention; and

FIG. 11 is a schematic view showing the organic electroluminescent device manufactured by the method according to the third embodiment of the invention.

### DETAILED DESCRIPTION OF THE INVENTION

The organic electroluminescent device and the manufacture method thereof will be described below with reference to relevant drawings.

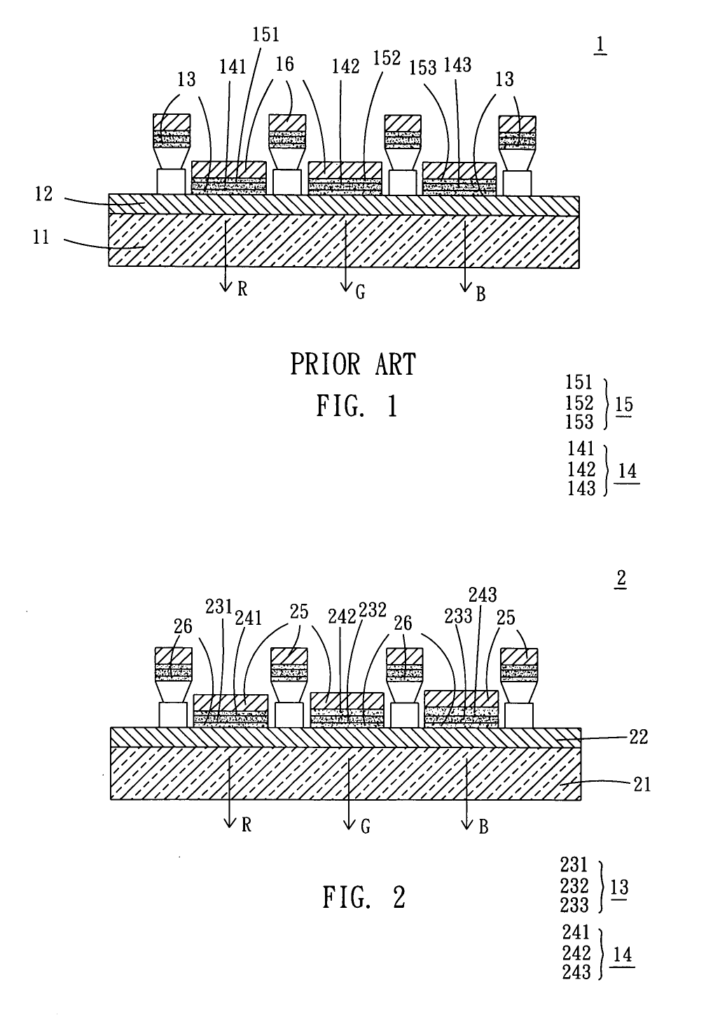

Refer to FIG. 2, the organic electroluminescent device according the first embodiment comprises a transparent substrate 2l, a first electrode 22, an organic light-emitting layer 23, an electron-injecting layer 24 and a second electrode 25, wherein the first electrode 22, the organic light-emitting layer 23, electron-injecting layer 24 and the second electrode 25 are respectively disposed on the transparent substrate 21 in order.

Refer to FIG. 2, the transparent substrate 21 may be a glass substrate. Herein, the transparent substrate 21 also may be a plastic substrate or a flexible substrate. The plastic substrate and the flexible substrate may be a polycarbonate (PC) substrate, a polyester (PET) substrate, a cyclic olefin copolymer (COC) substrate or a metallocene-based cyclic olefin copolymer (mCOC) substrate.

Refer to FIG. 2 again, the first electrode 22 is disposed on the transparent substrate 21. Herein, the first electrode 22 usually serves as an anode and the material thereof is usually a transparent conductive metal oxide, such as indium tin oxide (ITO), aluminum zinc oxide (AZO), indium zinc oxide (IZO), or the like.

Refer to FIG. 2, the organic light-emitting layer 23 is disposed on the first electrode 22. In the embodiment according to the invention, the organic light-emitting layer 23 includes a first organic electroluminescent unit 231, a second electroluminescent unit 232 and a third organic electroluminescent unit 233. The first organic electroluminescent unit 231, the second organic electroluminescent unit 232 and the third organic electroluminescent unit 233 are respectively comprised CN-PPV, MEH-PPV and DPBP-PPV in order, emitting the red light (indicated by arrow R), the green light(indicated bi arrow G)and the blue light(indicated by arrow B).

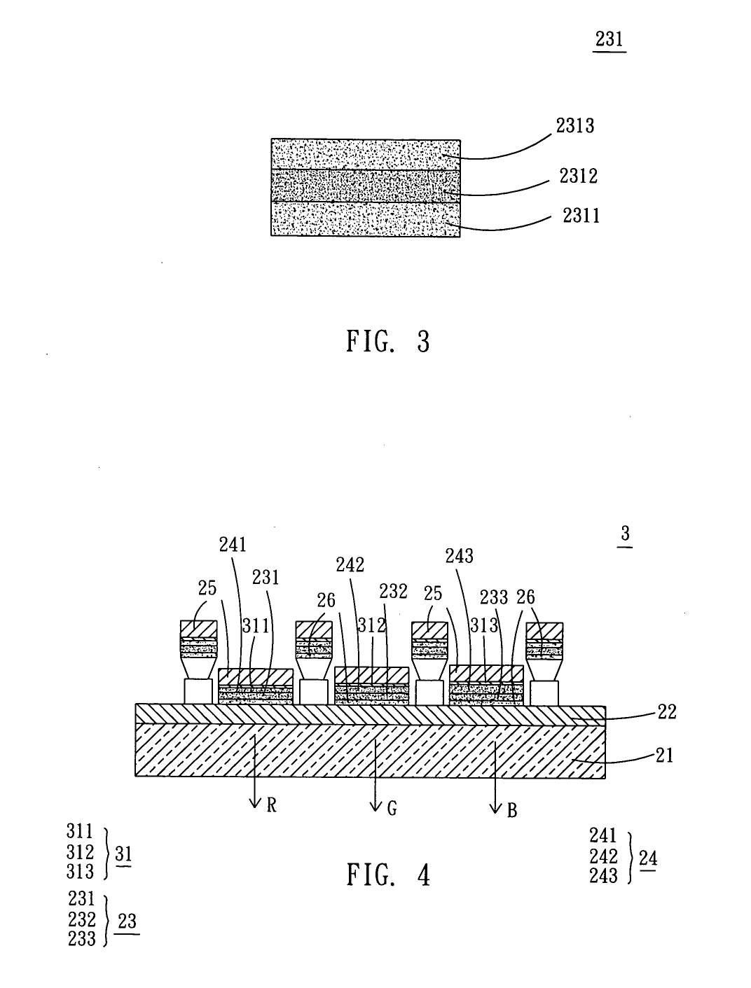

Please refer to FIG. 3, in the embodiment according to the invention, the organic light-emitting layer 23 includes a hole-transporting layer (HTL) 2311, an light-emitting layer (EML) 2312 and an electron-transporting layer (ETL) 2313. Here, the structure of the organic light-emitting layer 23 can also include EML/ETL, HTL/EML/ETL, HTL/EML or other structure. The EML 2312 can be comprised organic polymer materials, including but not limited to CN-PPV, MEH-PPV or DPBP-PPV. The EML 2312 can also be comprised small molecular organic materials, including but not limited to Alq:MQA, Beq₂:QA, DPVPi:DSA, or other suitable organic materials.

Please refer to FIG. 2, the electron-injecting layer 24 is disposed on the organic light-emitting layer 23, and includes a plurality of electron-injecting units. At least two electron-injecting units are comprised different materials. In the present embodiment, the electron-injecting layer 24 includes a first electron-injecting unit 241, a second electron-injecting unit 242 and a third electron-injecting unit 243. The first electron-injecting unit 241, the second electron-injecting unit 242 and the third electron-injecting unit 243 are comprised barium (Ba), calcium (Ca) and lithium fluoride (LiF). The first electron-injecting unit 241 is disposed on the first organic electroluminescent unit 231, the second electron-injecting unit 242 is disposed on the second organic electroluminescent unit 232, and the third electron-injecting unit 243 is disposed on the third organic electroluminescent unit 233. This arrangement improves the electron-injecting efficiency between the organic electroluminescent units 231, 232, 233 and the second electrode 25, and allows the electron-injecting units 241, 242 and 243 to have different thicknesses in view of practical requirements.

In the present embodiment, the electron-injecting units composed of the same material can be disposed on the organic electroluminescent units comprised different materials. For example, the electron-injecting unit comprised of Ba can be disposed on the organic electroluminescent units emitting red and blue light, and the electron-injecting unit comprised Ca can be disposed on the organic electroluminescent units emitting green light. Similarly, the electron-injecting units composed of different materials can be disposed on the organic electroluminescent units composed of the same material in view of practical requirements.

At least two of the materials of the electron-injecting units are selected from alkaline metal, alkaline-earth metal, lanthanides, alkaline metal halide, alkaline-earth metal halide, or lanthanide halide. The alkaline metal includes but not limited to lithium or sodium. The alkaline-earth metal includes but not limited to magnesium, barium or calcium. The lanthanide includes but not limited to samarium (Sm), thulium (Tm), terbium (Tb) or ytterbium (Yb). The alkaline metal halide includes but not limited to LiF, NaF or CsF. The alkaline-earth metal halide includes but not limited to MgF₂, BaF₂ or CaF₂. The lanthanide halide includes but not limited to SmI_{2.}

Please refer to FIG. 2 again, the second electrode 25 is disposed on the electron -injecting layer 24. In the embodiment, the material of the second electrode 25 may be one selected from the group consisting of aluminum (Al), calcium (Ca), magnesium (Mg), indium (In), tin (Sn), manganese (Mn), silver (Ag), gold (Au) and magnesium-containing alloy (e.g., magnesium-silver (Mg:Ag) alloy, magnesium-indium (Mg:In) alloy, magnesium-tin (Mg:Sn) alloy, magnesium-antimony (Mg:Sb) alloy, or magnesium-tellurium (Mg:Te) alloy), and the like.

Please refer to FIG. 2, the organic electroluminescent device 2 according to the embodiment of the invention further includes a hole injecting layer 26. The hole injecting layer 26 is disposed between the first electrode 22 and the organic light-emitting layer 23.

As shown in FIG. 4, the organic electroluminescent device 2 according to the embodiment further includes a metal layer 31 disposed on the electron-injecting layer 24. The metal layer 31 includes a plurality of metal units.

In the present embodiment, the metal layer 31 includes a first metal unit 311, a second metal unit 312 and a third metal unit 313. The first metal unit 311, the second metal unit 312 and the third metal unit 313 are all made of aluminum. It should be noted that the metal units may also be made of at least one of Li, Mg, Ag, Mg-Ag alloy, Au or other metal or alloy, and the materials and thickness of the metal units may be different in view of practical requirements.

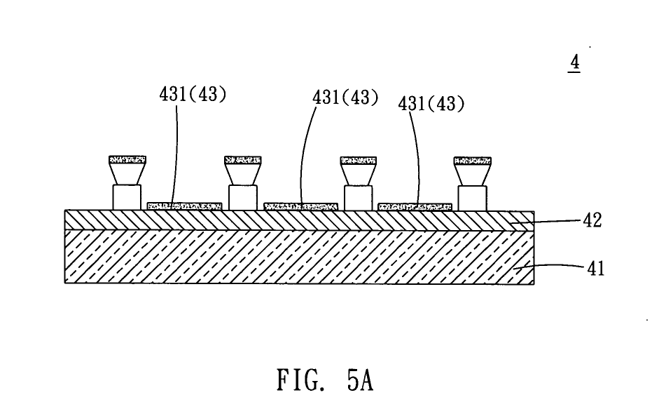

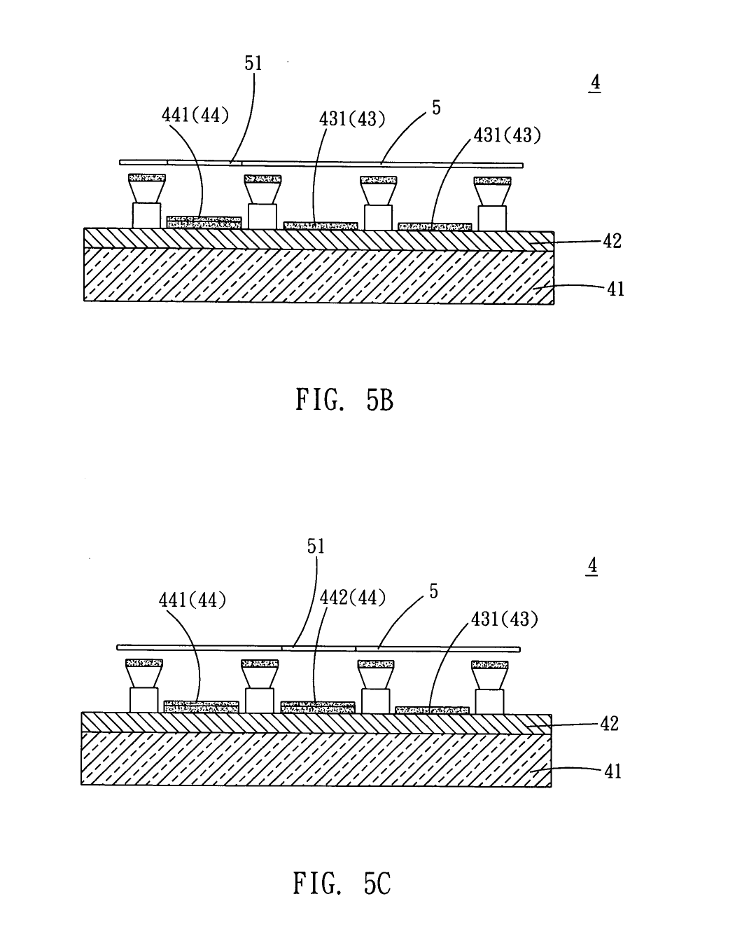

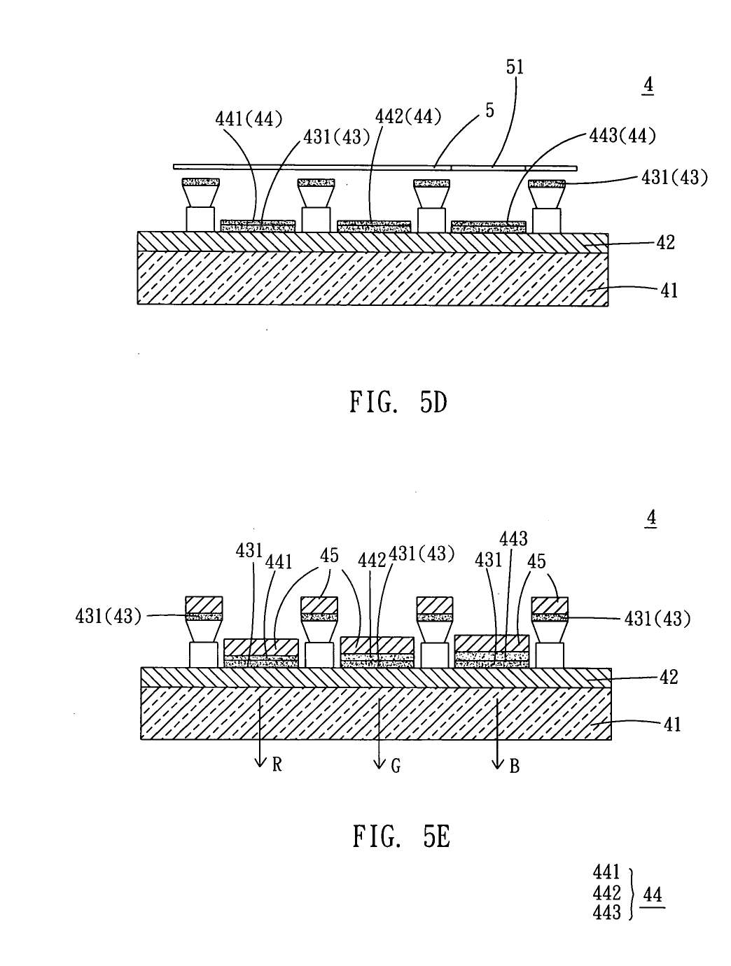

Please refer to FIGS. 5A, 5B, 5C, 5D and 5E, which illustrate the manufacture method of the organic electroluminescent device 4 according to another embodiment of the invention. Firstly, a first electrode layer 42 is formed on a transparent substrate 41. Then, an organic light-emitting layer 43 including a plurality of organic electroluminescent units 431 is formed on the first electrode layer 42. An electron-injecting layer 44 including a plurality of electron-injecting units is then formed on the organic light-emitting layer 43 using a mask 5. Finally, a second electrode layer 45 is formed on the electron-injecting layer 44. In the present embodiment, at least two of the electron-injecting units are made of different materials, and the thickness of the electron-injecting units may be different in view of practical requirements.

The more detailed procedure of the method of manufacturing the organic electroluminescent device according to the embodiment will be described below.

Please refer to FIG. 5A, the first electrode layer 42 is formed in the transparent substrate 41 in the first step. In the present embodiment, the transparent substrate 41 is a glass substrate, and the first electrode layer 42 is made of indium tin oxide (ITO). The features and functions of the transparent substrate 41 and the first electrode layer 42 are the same to the transparent substrate 21and the first electrode layer 22 described previously, so the detailed descriptions are omitted here for concise purpose.

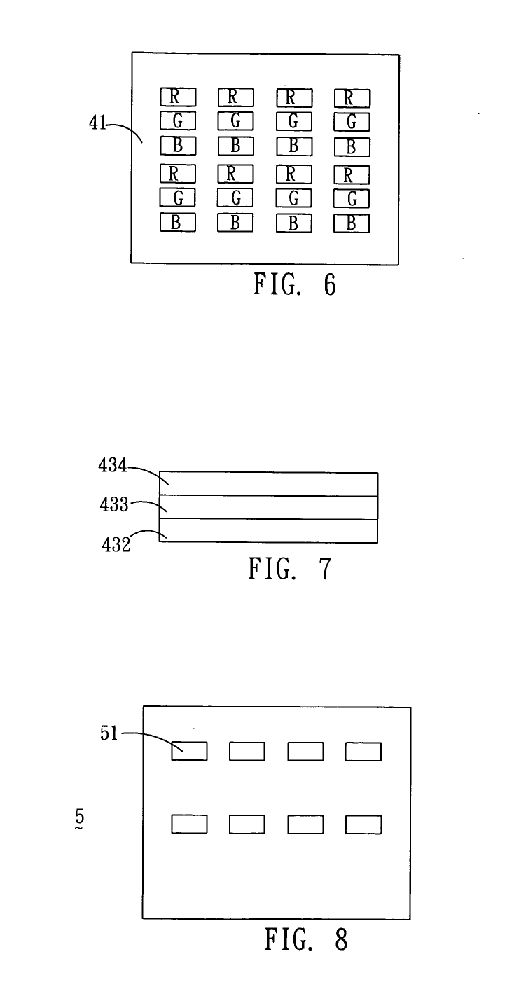

After the first electrode layer 42 being formed, an organic light-emitting layer 43 is formed on the first electrode, as shown in FIG. 5A. The organic light-emitting layer 43 includes a plurality of organic electroluminescent units 431, and the organic electroluminescent unit 431 is an independent light source. The materials of the organic electroluminescent units 431 are selected in view of the colors of the lights to be emitted. Please refer to FIG. 6, in the present embodiment, the organic light-emitting layer 43 includes a plurality of first organic electroluminescent units (labeled as R), a plurality of second organic electroluminescent units (labeled as G), and a plurality of third organic electroluminescent units (labeled as B). The first, the second, and the third organic electroluminescent units are made of different materials, and emit red, green and blue lights respectively.

Please refer FIG. 7, the characteristics and functions of the organic light-emitting layer 43 is the same as the organic light-emitting layer 23, and detailed descriptions thereof will be omitted.

Please refer to FIGS. 5B, 5C, 5D, 6 and 8, according to the present embodiment, after the forming of the organic light-emitting layer 43, an electron-injecting layer 44 is formed on the organic light-emitting layer 43. In the present embodiment, this step is accomplished by first moving a mask 5 so that an opening 51 is aligned with the first organic electroluminescent unit (labeled as R), and forming a first electron -injecting unit 441 on the first electroluminescent unit. Then, the mask 5 is offset so that its opening 51 to aligned with the organic electroluminescent unit (labeled as G) to form a second electron-injecting unit 442. After that, the mask S is offset again to align the opening 51 with the organic electroluminescent unit (labeled as B) to form a third electron-injecting unit 443.

As shown in FIG. SD, in the present embodiment, the first electron-injecting unit 441, the second electron-injecting unit 442 and the third electron-injecting unit 443 are formed of a first material, a second material, and a third material respectively The first material, the second material, and the third material are different materials, and the electron-injecting layer 44 includes the first electron-injecting unit 441, the second electron-injecting unit 442, and the third electron-injecting unit 443. Herein, the characteristics and functions of the electron-injecting layer is the same as the electron-injecting layer 23, and detailed descriptions thereof will be omitted.

Please refer to FIG. 5E again, after the forming of the electron-injecting layer 44, a second electrode layer 45 is formed on the electron-injecting layer 44.

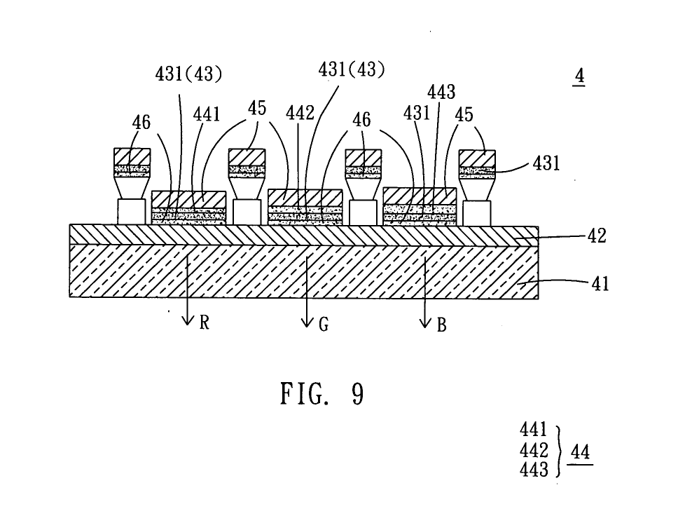

As shown in FIG. 9, after the forming of the first electrode layer 42, a hole injecting layer 46 may be formed on the first electrode layer 42. The hole injecting layer 46 is formed between the first electrode layer 42 and the organic light-emitting layer 43.

The forming of the electron-injecting layer can be divided into at least two stages. Please refer to FIG. 6, in the present embodiment, the forming of the electron-injecting layer includes three stages. In the first stage, the first electron-injecting unit is formed on the organic electroluminescent unit labeled as R. In the second stage, the second electron-injecting unit is formed on the organic electroluminescent unit labeled as G. In the third stage, the third electron-injecting unit is formed on the organic electroluminescent unit labeled as B.

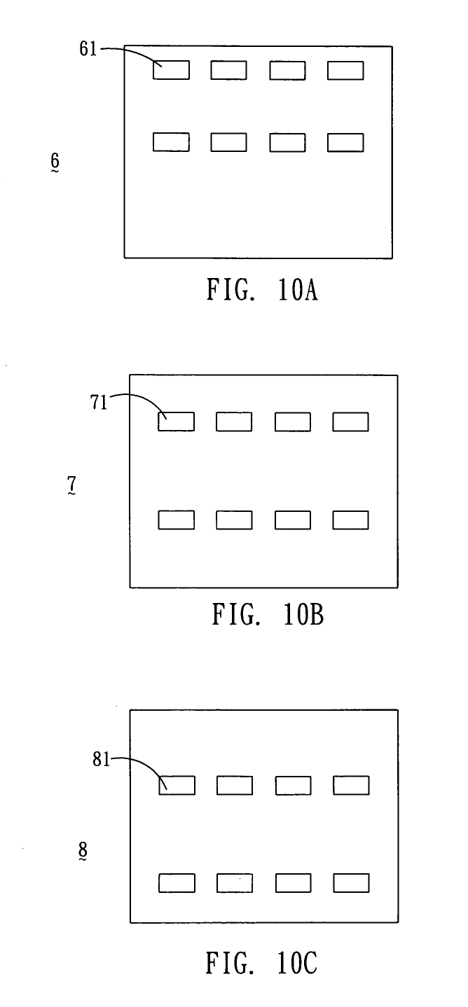

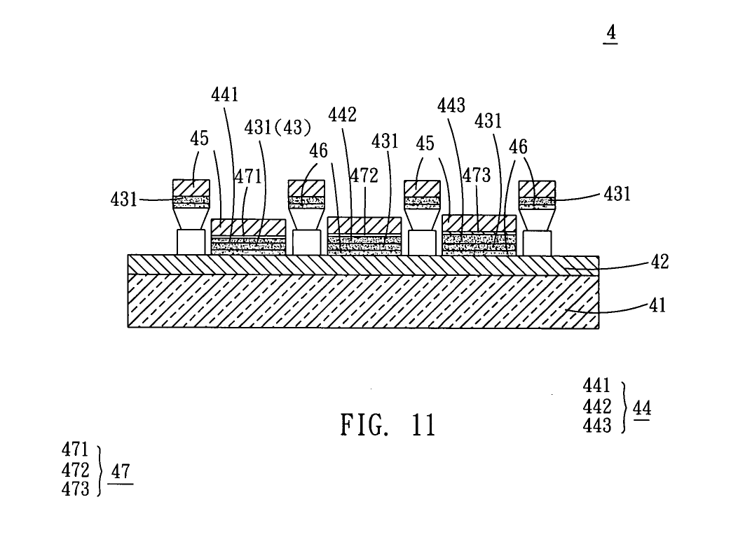

Furthermore, one can use multiple masks to form the electron-injecting layer on the organic light-emitting layer. Please refer to FIGs. 10A, 10B and 10C, after forming the organic light-emitting layer, an electron-injecting layer is formed on the organic light-emitting layer. In the present embodiment, when forming an electron- injecting layer on the organic electroluminescent unit shown in FIG. 7, a first mask 6 having multiple openings 61 is moved, and a plurality of first electron-injecting units are formed on the organic electroluminescent units labeled as R through the openings 61 of the first mask 6. Then, a second mask 7 having multiple openings 71 is moved, and a plurality 6f second electron-injecting units are formed on the organic electroluminescent units labeled as G through the openings 71 of the second mask 7. After that, a third mask 8 having multiple openings 81 is moved, and a plurality of third electron-injecting units are formed on the organic electroluminescent units labeled as B through the openings 81 of the third mask 8.

Here, the first electron-injecting unit, the second electron-injecting unit and the third electron-injecting unit are formed of a first material, a second material, and a third material, respectively, and the first material, the second material and the third material are different materials. The electron-injecting layer includes the first electron-injecting unit, the second electron-injecting unit, and the third electron-injecting unit. The material of the electron-injecting layer may be, but not limited to, LiF, Ba or Ca.

Moreover, in the method of manufacturing the organic electroluminescent device 4 according to a third embodiment of the invention, a first electrode layer 42 is formed on a transparent substrate 41. Then an organic light-emitting layer 43 including a plurality of organic electroluminescent units 431 is formed on the first electrode layer 42. At least one first electron-injecting unit 441 is then formed on the organic light-emitting layer 43, wherein the electron-injecting unit. 441 is made of a first material. At least one second electron-injecting unit 442 is then formed on the organic light-emitting layer 43, wherein the electron-injecting unit 442 is made of a second material different from the first material. The first electron-injecting unit 441 and the second electron-injecting unit 442 constitute an electron-injecting layer 44. Afterwards, a first metal unit 471 and a second metal unit 472 are formed on the first 441 and the second electron-injecting unit 442 respectively. The first metal unit 471 and the second metal unit 472 constitute a metal layer 47. A second electrode layer 45 is then formed on the metal layer 47. In the present embodiment, the thickness of the first electron-injecting unit 441 and the second electron-injecting unit 442 may be different in view of practical requirements.

In the present embodiment, as shown in FIG. 8, the first metal unit 471 is formed after the first electron-injecting unit 441 being formed in the first stage. The second metal unit 472 is formed after the second electron-injecting unit 442 being formed in the second stage. The third metal unit 473 is formed after the third electron- injecting unit 443 being formed in the third stage.

Please refer to FIG. 11, the first metal unit 471, the second metal unit 472 and the third metal unit 473 constitute a metal layer 47. The first metal unit 471, the second metal unit 472 and the third metal unit 473 prevent the electron-injecting units 441, 442 and 443 from being oxidized after being formed and before the forming of the second electrode layer 45. Furthermore, the materials of the metal units 471, 472 and 473 can be at least one selected from, but not limited to, Al, Li, Mg, Ag, Mg-Ag alloy, Au, other metal or alloy The first metal unit 471, the second metal unit 472 and the third metal unit 473 can be made of different materials, and can have different thickness in view of actual requirements.

In the present embodiment, using a single mask to form the electron-injecting layer can reduces the time required to change masks and the cost of multiple masks. When using multiple masks to form the electron-injecting layer, the number and locations of the openings on the mask can be designed according to the number and positions of the corresponding electron-injecting units. Thus, the position of the electron-injecting unit is not limited to the positions of the openings of a single mask.

In general, since the organic electroluminescent device according to the invention has multiple electron-injecting units, and at least two electron-injecting units are made of different materials, one can provide electron-injecting units made of different materials for different organic electroluminescent units, and the organic electroluminescent unit may have different thickness. Therefore, the electron-injecting efficiency between the second electrode and the organic light-emitting layer can be enhanced, and the color purity, the brightness and the light-emitting efficiency can be improved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An organic electroluminescent device, comprising:
a transparent substrate;
a first electrode disposed on the transparent substrate;
an organic light-emitting layer disposed on the first electrode, the organic light-emitting layer including a plurality of organic electroluminescent units;
an electron-injecting layer disposed on the organic light-emitting layer, the electron-injecting layer including a plurality of electron-injecting units, and at least two of the electron-injecting units are made of different materials; and
a second electrode disposed on the electron-injecting layer.

2. The organic electroluminescent device according to claim 1, wherein at least two of the materials of the electron-injecting units are selected from the group consisting of alkaline metal, alkaline-earth metal, lanthanides, alkaline metal halide, alkaline-earth metal halide, and lanthanide halide.

3. The organic electroluminescent device according to claim 1, wherein at least two of the electron-injecting units have different thicknesses.

4. The organic electroluminescent device according to claim 1, wherein the material of the transparent substrate is one selected from the group consisting of glass substrate, plastic substrate, and flexible substrate.

5. The organic electroluminescent device according to claim 1, wherein the material of the first electrode is one selected form the group consisting of indium tin oxide, indium zinc oxide, and aluminum zinc oxide.

6. The organic electroluminescent device according to claim 1, wherein the material of the second electrode is one selected form the group consisting of aluminum, calcium, magnesium, indium, tin, manganese, silver, gold, and magnesium alloy.

7. The organic electroluminescent device according to claim 1, wherein the organic light-emitting layer comprises sequentially a hole-transporting layer, an emitting layer and a electron-transporting layer, wherein the hole-transporting layer is disposed on the first electrode.

8. The organic electroluminescent device according to claim 1, wherein the organic light-emitting layer comprises sequentially an emitting layer and an electron-transporting layer, wherein the emitting layer is disposed on the first electrode.

9. The organic electroluminescent device according to claim 1, wherein the organic light-emitting layer comprises sequentially a hole-transporting layer and an emitting layer, wherein the hole-transporting layer is disposed on the first electrode.

10. The organic electroluminescent device according to claim 1, wherein the organic light-emitting layer comprises an emitting layer, wherein the emitting layer is disposed on the first electrode.

11. The organic electroluminescent device according to claim 1, further comprising a metal layer disposed on the electron-injecting layer, the metal layer including a plurality of metal units.

12. The organic electroluminescent device according to claim 11, wherein the material of the metal units are selected from the group consisting of aluminum, lithium, magnesium, silver and magnesium-silver alloy.

13. The organic electroluminescent device according to claim 11, wherein at least two of the metal units are made of different materials.

14. The organic electroluminescent device according to claim 11, wherein at least two of the metal units have different thicknesses.

15. A method of manufacturing an organic electroluminescent device, comprising the steps of:
forming a first electrode layer on a transparent substrate;
forming an organic light-emitting layer on the first electrode layer, the organic light-emitting layer including a plurality of organic electroluminescent units;
forming at least one first electron-injecting unit on the organic light-emitting layer constituting an electron injecting layer, the first electron-injecting unit being made of a first material;
forming at least one second electron-injecting unit on the organic light-emitting layer, the second electron-injecting unit being made of a second material different from the first material; and
forming a second electrode layer on the electron-injecting layer.

16. The method of manufacturing an organic electroluminescent device according to claim 15, wherein the first electron-injecting unit and the second electron-injecting unit have different thicknesses.

17. The method of manufacturing an organic electroluminescent device according to claim 15, wherein at least two of the materials of the first electron-injecting unit and the second electron-injecting unit are selected from the group consisting of alkaline metal, alkaline-earth metal, lanthanides, alkaline metal halide, alkaline-earth metal halide, and lanthanide halide.

18. The method of manufacturing an organic electroluminescent device according to claim 15, further comprising the step of:
after forming the electron-injecting layer, forming a first metal unit and a second metal unit on the first electron-injecting unit and the second electron-injecting unit respectively, the first metal unit and the second metal unit constituting a metal layer, the metal layer being formed between the electron -injecting layer and the second electrode layer.

19. The method of manufacturing an organic electroluminescent device according to claim 18, wherein the material of the first metal units and the second metal unit are selected from the group consisting of aluminum, lithium, and magnesium.

20. The method of manufacturing an organic electroluminescent device according to claim 18, wherein the first metal unit and the second metal unit have different thicknesses.
